(19) United States
(12) Patent Application Publication
(10) Pub. No.: US 2011/0246637 A1
(43) Pub. Date: Oct. 6, 2011

(54) COMMUNICATION DEVICE, COMMUNICATION SYSTEM, COMMUNICATION CONTROL METHOD AND COMMUNICATION CONTROL PROGRAM

(76) Inventor: Takuya Murakami, Tokyo (JP)

(21) Appl. No.: 13/132,476

(22) PCT Filed: Dec. 17, 2009
(86) PCT No.: PCT/JP2009/006946

§ 371 Date: Jun. 22, 2011

(30) Foreign Application Priority Data
Dec. 18, 2008 (JP) 2008-322093

(51) Int. Cl. G06F 15/173

(52) U.S. Cl. 709/223

(57) ABSTRACT

A communication device of the present invention is a communication device that operates in a plurality of operating modes including a managing unit for controlling operation in a managing mode capable of managing a managed communication device, the managed communication device having a managed unit for controlling operation in a managed mode of performing communication under management of the other communication device, and an operating mode setting unit for changing the operating mode to the managing mode when the communication device receives a response request signal from the managed communication device during operation in another operating mode than the managing mode.

### TECHNICAL FIELD

The present invention relates to a communication device, a communication system, a communication control method and a communication control program, and in particular, to a communication device, a communication system, a communication control method and a communication control program that include a managing mode capable of managing other communication device as an operating mode.

### BACKGROUND ART

The wireless LAN (Local Area Network) based on the IEEE802.11 Standard standardized by the Institute of Electrical and Electronic Engineers (IEEE) 802 committee adopts two types of different communication modes having different network structures. One is an “infrastructure mode” and the other is an “ad hoc mode”. In the infrastructure mode, an access point (hereinafter referred to as “AP”) as a wireless base station manages a network. A terminal (station, hereinafter referred to as “STA”) is connected to the AP and performs communication via the AP. In the “ad hoc mode”, STAs directly communicate with each other without using the AP. Hereinafter, the “wireless LAN based on the IEEE802.11 Standard” is referred to as “IEEE802.11 wireless LAN”.

Generally, the AP and the STA each are configured as a dedicated device, and however, some communication devices have functions of both of the AP and the STA (Refer to, for example, Patent document 1). In the communication device described in Patent document 1, a new group is added to an existing group formed of an AP and STAs. One STA requesting group addition requests another STA to set a group. The STA itself receiving the request becomes the AP and sets a new group. The “group” in Patent document 1 means a basic network corresponds to BSS (Basic Service Set) in the IEEE802.11 wireless LAN.

Also, some mobile wireless terminals can be simultaneously connected to the wireless LAN and a cellular network (Refer to, for example, Patent document 2). The mobile wireless terminal described in Patent document 2 provides an interface for the wireless LAN according to a connection request from a neighboring mobile wireless terminal. At this time, a network of the infrastructure mode or the ad hoc mode is constructed.

The IEEE802.11 Standard defines a power management function for reducing power consumption of the STA as a “power saving mode”. In the power saving mode, the STA can shift to a “doze state” in which the STA operates with minimum necessary electric power by stopping its transmission/reception function. However, the Standard does not define a power saving mode for the AP. This is due to that the AP acts to manage the whole network and must continue to wait a signal to be transmitted from the STA at all times, and therefore, its transmission/reception function should not be stopped. This causes a problem that the communication device operating as the AP consumes the battery much. Some methods for solving the above-mentioned problem in the AP have been proposed.

According to one example of the proposed methods, when no STA is connected, the AP shifts to the “power saving mode”, thereby reducing power consumption (Refer to, for example, Patent document 3). When being informed of movement of the STA from another AP, the AP described in Patent document 3 shifts from the power saving mode to a normal operating mode.

[Patent document 1] Unexamined Patent Publication No. 2008-035375 (pages 8 and 12, FIG. 9)

[Patent document 2] Unexamined Patent Publication No. 2004-320132 (pages 9 and 12, FIGS. 6 and 8)

[Patent document 3] Unexamined Patent Publication No. 2006-332844 (pages 4 to 7, FIGS. 5 to 7)

### SUMMARY OF THE INVENTION

In the communication device described in Patent document 1, the requesting STA needs to have a function of transmitting an operating mode change request signal for shifting another

STA to an AP mode. That is, the requesting STA needs to have the normal function for operating under management of the AP as well as the specific function for changing the operating mode.

When receiving the connection request from the requesting STA, the mobile wireless terminal described in Patent document 2 provides a wireless LAN interface to the STA. However, in order to transmit the connection request, the requesting STA requires another communication path, and thus, cannot transmit the connection request directly to a requested terminal. In other words, the art described in Patent document 2 is applicable only when some kind of communication unit is previously prepared.

According to the method described in Patent document 3, when the AP operates independently, the AP cannot be informed of movement of the STA. In other words, in order to shift the AP to the AP mode, another AP as a communication unit for informing movement of the STA is required.

The present invention is made in consideration of the above-mentioned technical problems and intends to provide a communication device for performing communication under management of other communication device, which can shift to an operating mode of managing a communication device having no function of transmitting an operating mode change request signal to other communication device according to a response request from the communication device, and requires no special communication path for responding the request; communication control method; and a communication control program.

The communication device according to the present invention is a communication device that operates in a plurality of operating modes and includes a managing unit for controlling operation in a managing mode capable of a managing managed communication device, the managed communication device having a managed unit for controlling operation in a managed mode of performing communication under management of other communication device, and an operating mode setting unit for changing the operating mode to the managing mode when the communication device receives a response request signal from the managed communication device during operation in another operating mode than the managing mode.

A communication system according to the present invention is a communication system including a communication device that operates in a plurality of operating modes, and a managed communication device having a managed unit for controlling operation in a managed mode of performing communication under management of other communication device, wherein the communication device has a managing unit for controlling operation in a managing mode capable of managing the managed communication device, and an operating mode setting unit for changing the operating mode to the managing mode when the communication device receives a response request signal from the managed communication device during operation in another operating mode than the managing mode.

A communication control method according to the present invention includes a step of changing an operating mode to a managing mode capable of managing other communication device when a response request signal is received from the other communication device during operation in another operating mode than the managing mode.

A communication control program according to the present invention allows a computer for controlling a communication device to implement a unit for changing an operating mode to a managing mode in which the communication device can manage other communication device when the communication device receives a response request signal from the other communication device during operation in another operating mode than the managing mode.

In the communication device, the communication system, the communication control method and the communication control program according to the present invention, when the response request signal is received from the requesting communication device, the operating mode is shifted to the managing mode to manage the requesting communication device. This causes an advantage that the requesting communication device does not need to have any special function of transmitting the operating mode change request signal. In addition, there is another advantage that, in order to receive the response request signal, any communication path other than the requested communication device and the requesting communication device is not required.

### BRIEF DESCRIPTION THE DRAWINGS

FIG. 1 is a block diagram showing configuration of a communication device in accordance with First exemplary embodiment of the present invention.

FIG. 2 is a block diagram showing configuration of a communication system in accordance with First exemplary embodiment.

FIG. 3 is a sequence chart showing operation of the communication system in accordance with First exemplary embodiment.

FIG. 4 is a flow chart showing operation of a first communication device in accordance with First exemplary embodiment.

FIG. 5 is a sequence chart showing operation of a communication system in accordance with Second exemplary embodiment of the present invention.

FIG. 6 is a flow chart showing operation of a first communication device in accordance with Second exemplary embodiment of the present invention.

FIG. 7 is a block diagram showing configuration of a communication system in accordance with Third exemplary embodiment of the present invention.

FIG. 8 is a sequence chart showing operation of the communication system in accordance with Third exemplary embodiment of the present invention.

FIG. 9 is a flow chart showing operation of a first communication device in accordance with Third exemplary embodiment of the present invention.

FIG. 10 is a sequence chart showing an alternative example of the operation of the wireless communication system in accordance with Third exemplary embodiment of the present invention.

FIG. 11 is a flow chart showing an alternative example of the operation of the first communication device in accordance with Third exemplary embodiment of the present invention.

FIG. 12 is a block diagram showing configuration of a wireless communication system in accordance with Fourth exemplary embodiment of the present invention.

FIG. 13 is a sequence chart showing operation of the wireless communication system in accordance with Fourth exemplary embodiment of the present invention.

FIG. 14 is a timing chart showing operation of a wireless communication system in accordance with Fifth exemplary embodiment of the present invention.

FIG. 15 is a timing chart showing operation of a wireless communication system in accordance with Sixth exemplary embodiment of the present invention.

### EXEMPLARY EMBODIMENTS

### First Exemplary Embodiment

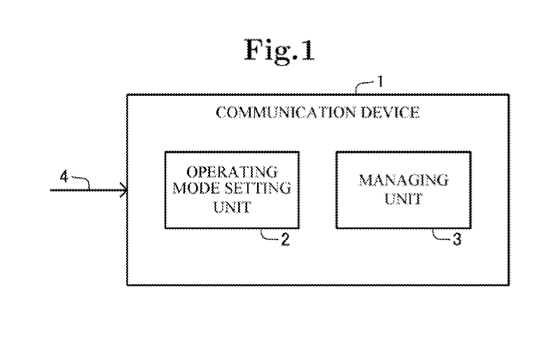

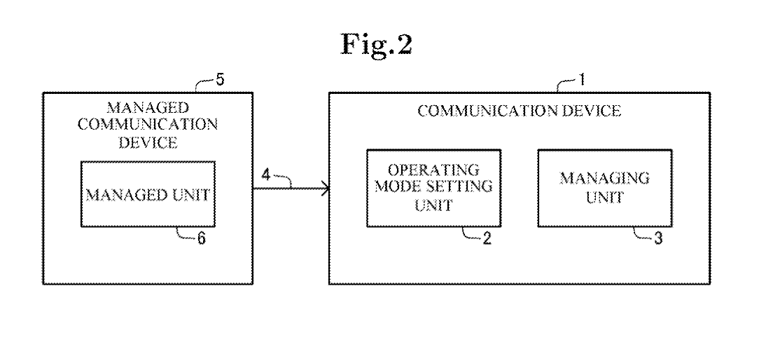

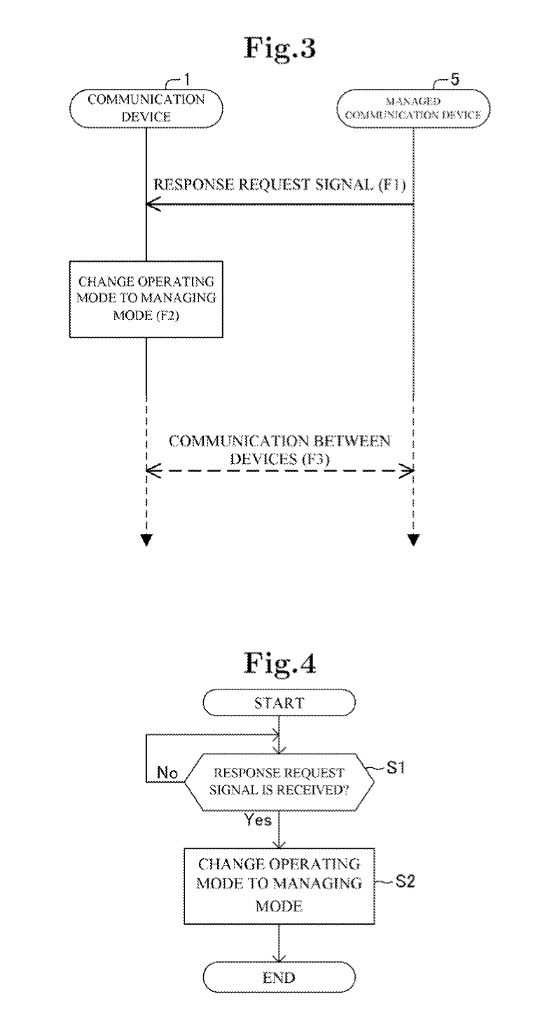

Next, First exemplary embodiment the present invention will be described in detail with reference to figures. FIG. 1 is a block diagram showing configuration of a communication device in accordance with First exemplary embodiment of the present invention. FIG. 2 is a block diagram showing configuration of a communication system in accordance with First exemplary embodiment. FIG. 3 is a sequence chart showing operation of the communication system in accordance with First exemplary embodiment. FIG. 4 is a flow chart showing operation of the communication device in accordance with First exemplary embodiment.

Referring to FIG. 1, FIG. 2, FIG. 3 and FIG. 4, First exemplary embodiment of the present invention will be described. In this exemplary embodiment, the configuration and the operation of the communication device and the communication system will be briefly described.

As shown in FIG. 1, the communication device 1 includes an operating mode setting unit 2 and a managing unit 3. The operating mode setting unit 2 and the managing unit 3 are realized, for example, by reading a program into a CPU (Central Processing Unit). The program stored in a storage medium such as a CD-ROM is provided to the communication device 1. Alternatively, the program may be stored in a storage device of a server computer on a network and then, the stored program may be provided from the server computer to the communication device 1 via the network.

The operating mode setting unit 2 sets an operating mode of the communication device 1. Here, the “operating mode” refers to an operation state representing the function performed In by the communication device. The operating mode of the communication device 1 includes a “managing mode” of managing other communication device. When the communication device 1 receives a response request signal 4 in another operating mode than the managing mode, that is, the operating mode that is different from the managing mode, the operating mode setting unit 2 changes the current operating mode to the managing mode. The “response request signal” is a signal transmitted from an external communication device that requests a response from surrounding communication devices including the communication device 1. Examples of the response request signal 4 include signals for confirmation existence/absence of the communication device operating in the managing mode, a request for belonging to the communication device operating in the managing mode and an authentication request.

When the operating mode is set to the managing mode, the managing unit 3 performs “managing processing” for managing other communication device.

While operating in the managing mode, as shown in FIG. 3, the communication device 1 forms a network along with a managed communication device 5 and manages the managed communication device 5 by means of the managing unit 3. The managed communication device 5 includes an managed unit 6 and performs “managed processing” for being under management of other communication device. In request for a response from the communication device 1, the managed communication device 5 transmits the response request signal. Although a communication line is not shown in FIG. 3, the communication device 1 and the managed communication device 5 can communicate with each other.

The above-mentioned “managing processing” and “managed processing” will be described. The “managing processing” is predetermined processing performed by the communication device 1 so that the managed communication device 5 can communicate with the communication device 1. As a specific example, the communication device 1 operates as follows:

1) authenticates the managed communication device 5, and

2) registers the managed communication device 5 as a communication device under management of the communication device land cancels the registration.

When the managing unit 3 performs the above-mentioned managing processing 1) and 2), the whole of the communication system performs operates as follows. The communication device 1 authenticates the managed communication device 5 and places the managed communication device 5 under management. The managed communication device 5 under management of the communication device 1 communicates with the communication device 1. Further, the managed communication device 5 may communicate with other communication device (not shown) via the communication device 1. That the managed communication device 5 comes under management of the communication device 1 is also referred to as that “the managed communication device 5 belongs to the communication device 1”. Specific examples of the communication device 1 and the managed communication device 5 are a base station and a mobile station in a mobile communication system, respectively, and the AP and the STA in the wireless LAN, respectively.

In another operating mode than the managing mode (the operating mode that is different from the managing mode), the operating mode of the communication device 1 may be an “managed mode” in which the communication device 1 is managed by other communication device operating in the managing mode. Alternatively, the operating mode of the communication device 1 may be a “normal mode” that is neither the managing mode nor the managed mode. In the managed mode, the communication device 1 performs the same operation as the managed communication device 5, which are described in this exemplary embodiment. Since the operation of the communication device 1 in the normal mode is not important in this exemplary embodiment, it is not specifically defined.

The managed communication device 5 includes the managed unit 6. In order to perform communication under management of the communication device 1, the managed unit 6 performs the “managed processing” as follows:

1) requests authentication of the managed communication device 5, and

2) request registration of the managed communication device 5 as a communication device under management of the communication device 1 and requests cancellation of the registration.

As described above, the managed processing is processing that pairs with the managing processing performed by the communication device 1 and requests other communication device to perform some kind of processing. To perform the managed processing, the managed unit 6 previously transmits the response request signal 4. In the managed processing, it is no need to designate a requested communication device. That is, the managed unit 6 may transmit the response request signal 4 without designating a communication device as destination and wait a response from any communication device that receives the response request signal 4.

Operation at and after shift of the operating mode of the communication device 1 from the managed mode or the normal mode to the managing mode will be mainly described.

The communication device 1 does not necessarily shift from the managed mode or the normal mode to the managing mode and may operate so as to be able to perform processing in a plurality of operating modes including the managing mode. In other words, the operation in the managing mode and the operation in one or both of the managed mode and the normal mode may be alternately performed in a time-sharing manner. Alternatively, the operation in the managing mode and the operation in one or both of the managed mode and the normal mode may be performed in parallel. In either case, in this exemplary embodiment, the operation in the managed mode and the normal mode does not affect the operation in the managing mode. For this reason, in this exemplary embodiment, the state where the communication device 1 operates in the single operating mode, that is, only the managing mode will be described in detail.

With reference to FIG. 3, the operation in this exemplary embodiment will be described. In an initial state, it is assumed that the communication device 1 operates in another operating mode than the managing mode, that is, the managed mode or the normal mode. First, the managed communication device 5 transmits the response request signal 4 (Step F1).

In this exemplary embodiment, the communication device 1 shifts the operating mode to the managing mode without transmitting a response signal to the response request signal 4 to the managed communication device 5. Assuming that other communication device (the communication device 1 in this exemplary embodiment) shifts to the managing mode, the managed communication device 5 starts communication without waiting the response signal to the response request signal 4. On the contrary, the managed communication device 5 may transmit the response request signal 4 and then, wait the response signal from the other communication device. In this case, after confirming the existence of the other communication device that operates in the managing mode or shifts to the managing mode, the managed communication device 5 can start communication.

When receiving the response request signal 4, the communication device 1 changes its to operating mode to the managing mode (Step F2). After the change of the operating mode to the managing mode, the communication device 1 places the managed communication device 5 under management. That is, the communication device 1 allows the managed communication device 5 to belong to the communication device 1. Then, the communication device 1 and the managed communication device 5 communicate with each other (Step F3).

With reference to FIG. 4, operation of the communication device 1 in this exemplary embodiment will be described. The communication device 1 determines whether or not the response request signal is received (Step S1). Then, when confirming reception of the response request signal, the communication device 1 changes its operating mode to the managing mode (Step S2).

In the communication system in this exemplary embodiment, the managed communication device 5 that attempts to operate in the managed mode can transmit the response request signal, thereby shifting the operating mode of the communication device 1 to the managing mode. At this time, the communication device 1 places the managed communication device 5 under management. Consequently, the managed communication device 5 can operate in the managed mode. Advantageously, especially when the managed communication device 5 is a communication device that can operate only in the managed mode, the managed communication device 5 can be put into a communicable state.

### Second Exemplary Embodiment

Subsequently, Second exemplary embodiment of the present invention will be described. When the communication between the communication device 1 and the managed communication device 5 as described in First exemplary embodiment is finished, the communication device 1 does not need to keep the operation in the managing mode. Thus, the communication device 1 in this exemplary embodiment has a function of cancelling the managing mode in addition to the configuration of the communication device 1 in First exemplary embodiment. Configuration of the communication network is as the same as that in First exemplary embodiment as shown in FIG. 2.

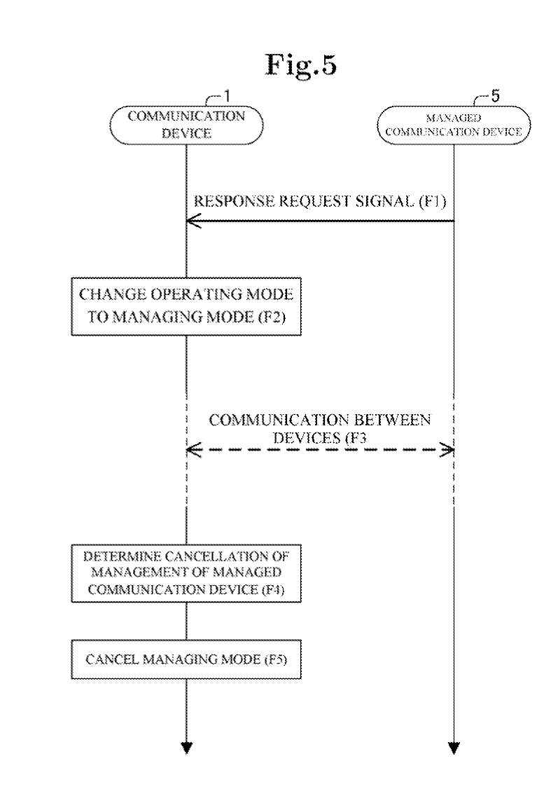

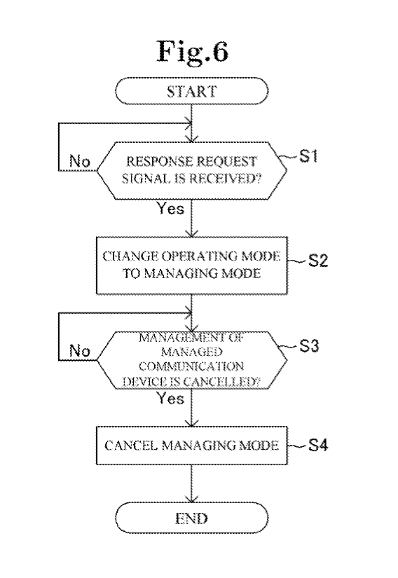

FIG. 5 is a sequence chart showing operation in accordance with Second exemplary embodiment of the present invention. FIG. 6 is a flow chart showing operation of a first communication device in accordance with Second exemplary embodiment.

With reference to FIG. 5, the operation of Second exemplary embodiment will be described. The operation up to the step in which the communication device 1 places the managed communication device 5 under management, and the communication device 1 and the managed communication device 5 communicate with each other (Step F3) is the same as that in First exemplary embodiment.

When the communication state between the communication device 1 and the managed communication device 5 satisfies a predetermined condition set in advance, for example, communication between the communication device 1 and the managed communication device 5 is finished, the communication device 1 determines whether or not management of the managed communication device 5 can be cancelled (Step F4). When determining that management of the managed communication device 5 can be cancelled, the communication device 1 cancels the managing mode (Step F5). Then, the operating mode of the communication device 1 shifts to another operating mode than the managing mode, that is, the operating mode that is different from the managing mode.

When the communication device 1 satisfies below-mentioned conditions, the communication device 1 can determine that management of the managed communication device 5 can be cancelled.

1) The communication device 1 receives a management cancellation request signal from the managed communication device 5.

2) The communication device 1 does not receive a signal from the managed communication device 5 for a predetermined time or more.

A plurality of communication devices may be under management of the communication device 1. In this case, the communication device 1 confirms that each of the communication devices under management satisfies the above-mentioned condition 1) or 2) and determines whether or not the management can be cancelled. Upon stopping management of all of the managed communication devices, the communication device 1 cancels the managing mode and shifts the operating mode to another mode than the managing mode.

FIG. 6 is a flow chart showing operation of the communication device 1 in Second exemplary embodiment. The operation up to the step of changing the operating mode to the managing mode (Step S2) is the same as that in First exemplary embodiment as shown in FIG. 4. Following the processing in Step S2, the communication device 1 determines whether or not management of the managed communication device 5 can be cancelled (Step S3). Then, when confirming that the cancellation is available, the communication device 1 cancels the managing mode (Step S4).

As described above, in the communication system in Second exemplary embodiment, when communication between the communication device 1 and the managed communication device 5 is finished, the communication device 1 cancels the managing mode. As a result, the communication device 1 can advantageously suppress increases in processing loads for performing the managing mode and power consumption to the minimum necessary.

### Third Exemplary Embodiment

Next, there will be described an embodiment in which the communication device operating under management of other communication device in the “managed mode” is shifted to the managing mode.

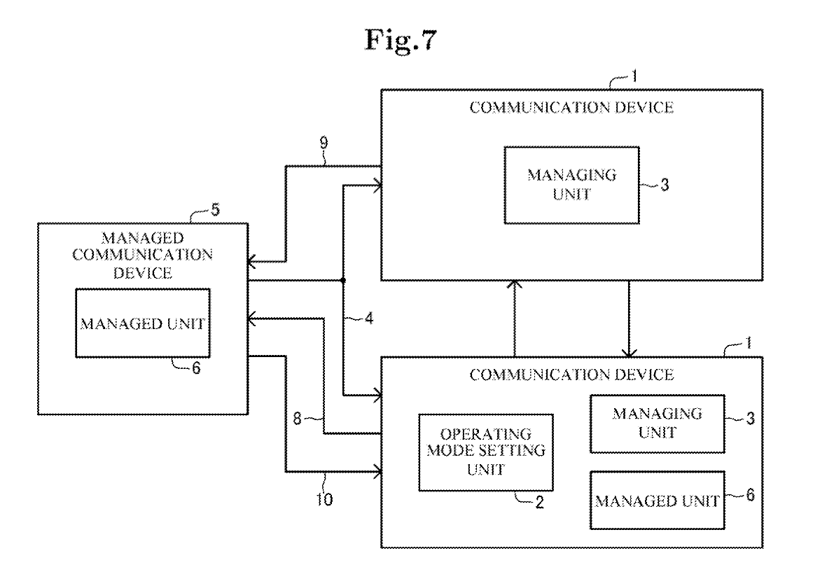

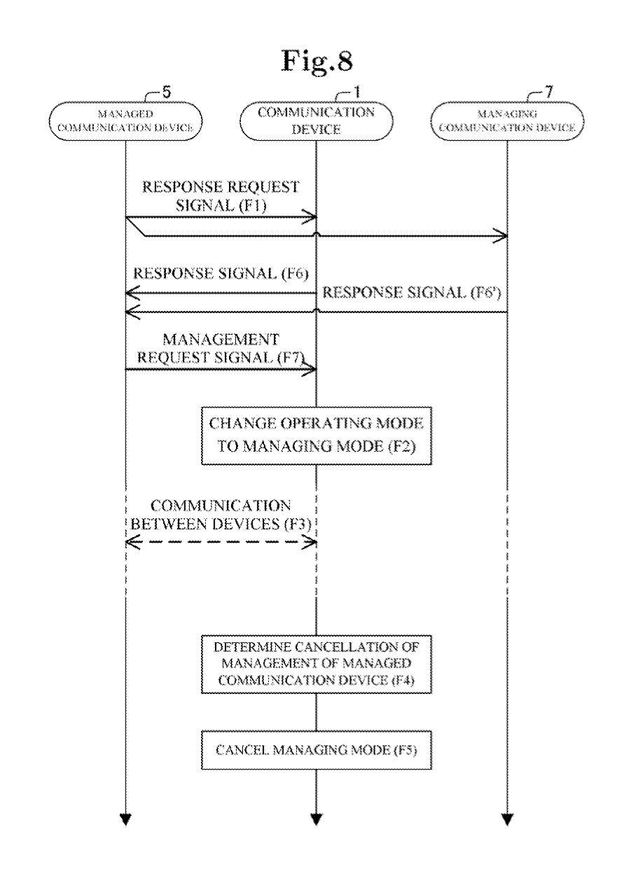

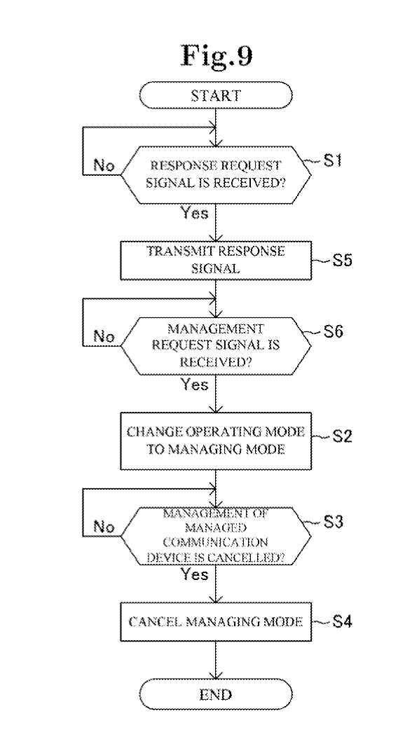

FIG. 7 is a block diagram showing configuration of a communication system in accordance with Third exemplary embodiment of the present invention. FIG. 8 is a sequence chart showing operation of the communication system in accordance with Third exemplary embodiment. FIG. 9 is a flow chart showing operation of a communication device in accordance with Third exemplary embodiment.

With reference to FIG. 7, FIG. 8 and FIG. 9, Third exemplary embodiment will be described. The communication system in Third exemplary embodiment includes a managing communication device 7 in addition to the communication device 1 and the managed communication device 5. This exemplary embodiment is characterized by that the communication device 1 belongs to the managing communication device 7.

The communication device 1 includes the operating mode setting unit 2, the managing unit 3 and the managed unit 6. The operating mode setting unit 2 and the managing unit 3 are the same as those in First exemplary embodiment.

The managing communication device 7 operates in the managing mode. The communication device 1 operates in the managed mode and belongs to the managing communication device 7.

The managed communication device 5 transmits the response request signal 4. When receiving the response request signal 4, the communication device 1 and the managing communication device 7 transmit a response signal 8 and a response signal 9, respectively.

With reference to FIG. 8, operation in Third exemplary embodiment will be described. First, the communication device 1 transmits the response request signal (Step F1). The response request signal is received by the communication device 1 as well as the managing communication device 7. The communication device 1 and the managing communication device 7 transmit the response signal 8 and the response signal 9, respectively, to the managed communication device 5 (Steps F6, F6′).

The managed communication device 5 that receives the response signal 8 and the response signal 9 selects either the communication device 1 or the managing communication device 7 as the communication device to which the managed communication device 5 belongs and transmits a belonging request signal to the selected communication device (Step F7).

When the managed communication device 5 selects the communication device 1 as the belonged communication device, the managed communication device 5 transmits a belonging request signal 10 to the communication device 1. At this time, the communication device 1 changes its operating mode to the managing mode by means of the operating mode setting unit 2 (Step F2). Alternatively, the communication device 1 may operate in the managing mode and the managed mode in a time-sharing manner or in parallel.

Then, the communication device 1 allows the managed communication device 5 to belong thereto as the communication device under management. After that, the communication device 1 and the managed communication device 5 communicate with each other (Step F3).

Then, when communication between the communication device 1 and the managed communication device 5 is finished, the communication device 1 determines whether or not management of the managed communication device 5 can be cancelled (Step F4). After that, according to a determination result, the communication device 1 cancels the management (Step F5). The operation of the communication device 1 for cancelling management of the managed communication device 5 is the same as that in Second exemplary embodiment.

When the managed communication device 5 receives the response signal 8 and the response signal 9 and selects the managing communication device 7 as the belonged communication device, the managed communication device 5 transmits the belonging request signal (not shown) to the managing communication device 7. Since the managing communication device 7 operates in the managing mode, the managing communication device 7 places the managed communication device 5 under management without changing its operating mode. The operation of the managing communication device 7 at this time is not especially characteristic and thus, illustration and description thereof are omitted.

FIG. 9 is a flow chart showing operation of the communication device 1 in Third exemplary embodiment. Step S1 is the same as that in Second exemplary embodiment as shown in FIG. 6. Following the processing in Step S1, the communication device 1 transmits the response signal 8 to the managed communication device 5 (Step S5). Next, the communication device 1 determines whether or not a management request signal 10 is received from the managed communication device 5 (Step S6). Then, when confirming that the management request signal 10 is received, the communication device 1 changes its operating mode to the managing mode (Step S2). Subsequent operation is the same as that in Second exemplary embodiment as shown in FIG. 6.

The operating mode of the communication device 1 at the time when the response request signal is received from the managed communication device 5 is not necessarily the managed mode. When the operating mode of the communication device 1 is the managing mode, the communication device 1 may perform the same operation as the managing communication device 7. When the operating mode of the communication device 1 is neither the managed mode nor the managing mode, as described above, the communication device 1 may transmit the response signal 8 to the response request signal 4 and change its operating mode to the managing mode as necessary.

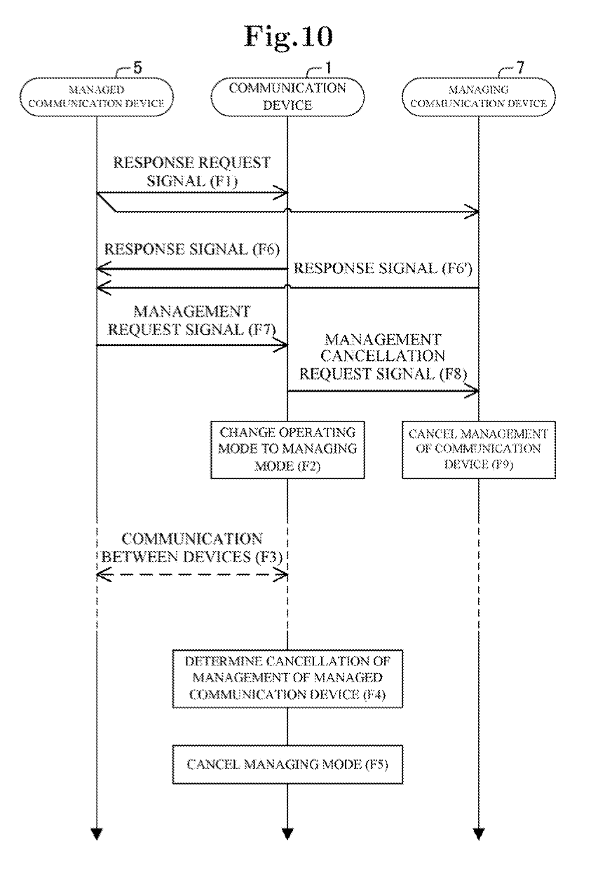

Before the communication device 1 changes its operating mode to the managing mode, there may be a case where the communication device 1 operates in the managed mode and belongs to the managing communication device 7. In this case, the operating mode may be changed to the managing mode after cancellation of the belonging relationship. FIG. 10 shows the operation in the case where the communication device 1 changes its operating mode to the managing mode after cancellation of the belonging relationship. In this case, before changing the operating mode to the managing mode, the communication device 1 transmits the management cancellation request signal to the managing communication device 7 (Step F8), and causes the managing communication device 7 to cancel management of the communication device 1 (Step F9). Further, the managing communication device 7 may transmit a response signal informing management cancellation to the communication device 1.

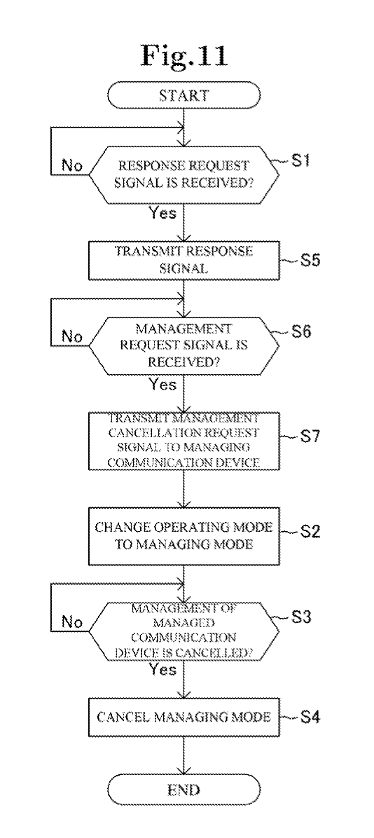

FIG. 11 is a flow chart showing operation of the communication device 1 in the case where the operating mode is changed to the managing mode after cancellation of the belonging relationship. In the flow chart in FIG. 11, transmission of the management cancellation request signal to the managing communication device 7 (Step S7) is added next to Step S6 (determination whether or not the management request signal is received) in FIG. 9. Subsequent processing in FIG. 11 is the same as that in FIG. 9.

As described above, in the communication system in Third exemplary embodiment, even if the communication device 1 does not operate in the managing mode, upon request of the managed communication device 5, the communication device can change its operating mode to the managing mode. This is advantageous in the case where no communication device operating in the managing mode exists despite that the managed communication device 5 needs to perform communication in the managed mode. That is, the managed communication device 5 can perform communication in the managed mode by causing any of surrounding communication devices to operate in the managing mode. This embodiment can be combined with each of other embodiments.

### Fourth Exemplary Embodiment

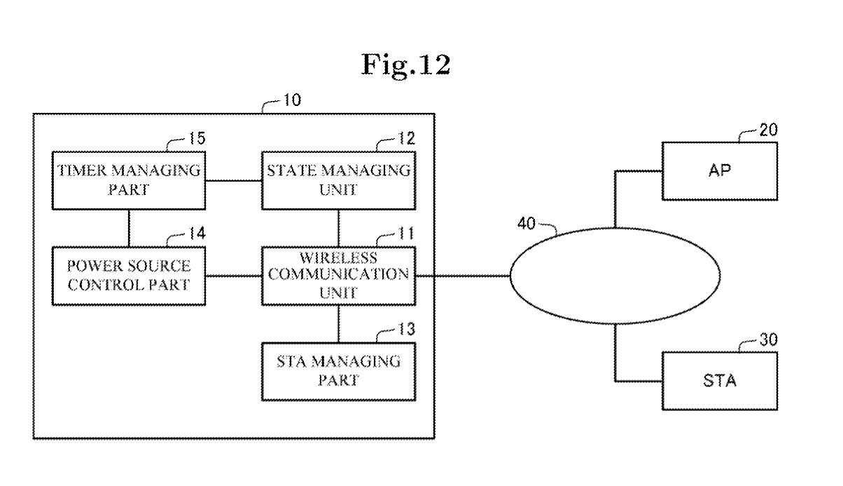

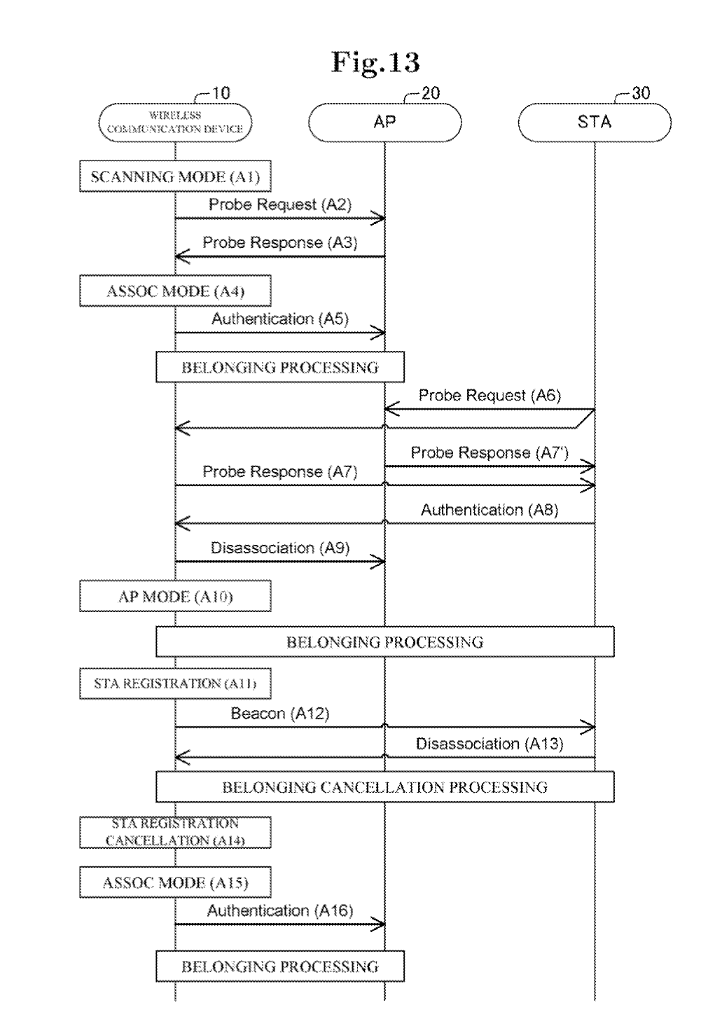

Next, an embodiment in the case where the present invention is applied to a specific communication system will be described with reference to figures. FIG. 12 is a block diagram showing configuration of a wireless communication system in accordance with Fourth exemplary embodiment of the present invention. FIG. 13 is a sequence chart showing operation of the wireless communication system in accordance with Fourth exemplary embodiment of the present invention.

A wireless communication device 10, an AP 20 and an STA 30 are connected to a wireless LAN 40 as a wireless communication system. The wireless communication device 10 communicates with other devices by use of the IEEE802.11 wireless LAN. The wireless communication device 10 has functions of both the AP and STA. The AP 20 and the STA 30 function as an access point and a station of the normal IEEE802.11 wireless LAN, respectively.

A wireless communication unit 11 is a device that performs a communication function as the wireless LAN. Specifically, the wireless communication unit 11 has functions of a physical layer and a MAC (Medium Access Control) layer of IEEE802.11, such as frame transmission/reception and carrier sense. It is assumed that the wireless communication unit 11 operates as either the STA or the AP. Functions and operation that are defined in the IEEE802.11 Standard are outside the scope of the present invention and thus, description thereof is confined to the minimum necessary.

A state managing unit 12 is a unit for setting the operating mode of the wireless communication device 10. The operating mode is classified into three modes: a “Scanning mode”, an “Association (hereinafter referred to as “Assoc”) mode and an “AP mode”. The wireless communication device 10 operates in any of these operating modes.

The “Scanning mode” refers to a state before the wireless communication device 10 belongs to the AP. In the Scanning mode, the wireless communication device 10 periodically transmits Probe Request to search the AP.

The “Assoc” mode refers to a state where the wireless communication device 10 is performing belonging processing to the AP or completes the belonging processing to the AP. In the Assoc mode, the wireless communication device 10 can communicate with the AP in the infrastructure mode. In the Scanning mode and the Assoc mode, the wireless communication device 10 operates as the STA. For this reason, in the following description, the Scanning mode and the Assoc mode may be collectively referred to as “STA mode” when they need not be distinguished from each other.

In the “AP mode”, the wireless communication device 10 operates as the AP. The wireless communication device 10 periodically transmits Beacon and manages belonging of other STA.

An STA managing part 13 is a unit for managing the belonging STA while the wireless communication device 10 operates as the AP. In this exemplary embodiment, the STA managing part 13 performs general management operation including management of BSS-ID (Identification) of the belonging STA, a key for encryption communication and non-communication time.

A power source control part 14 is a unit for power-saving control and mainly performs ON/OFF switching processing of a power source for the wireless communication unit 11. A tinier managing part 15 manages a timer for power source control. The power-saving control by the power source control part 14 and the management of the timer for power source control by the timer managing part 15 are performed only when the state managing unit 12 sets the operating mode to the Scanning mode or the Assoc mode.

Next, with reference to FIG. 12, FIG. 13, the operation of this exemplary embodiment will be described.

When the wireless communication device 10 is activated, the state managing unit 12 sets the operating mode to the initial Scanning mode (Step A1). In this state, the wireless communication device 10 operates as the STA and the wireless communication unit 11 transmits Probe Request at regular intervals to search the AP (Step A2).

When the wireless communication device 10 comes closer to the AP 20, the AP 20 receives Probe Request. Then, the AP 20 sends Probe Response containing ESS (Extended Service Set)-ID of the AP 20 itself as a response to Probe Request (Step A3). Operation of the AP 20 in Step A3 is a normal operation of the AP 20.

When receiving Probe Response, the wireless communication unit 11 recognizes existence of the AP. Then, the state managing unit 12 changes the operating mode of the AP 20 to the Assoc mode (Step A4). As described above, the Assoc mode refers to the state where the wireless communication device 10 finds a surrounding AP and communicates with the found AP in the infrastructure mode. The wireless communication unit 11 transmits Authentication to the AP 20 and starts the belonging processing (Step A5). In the belonging processing, according to a sequence defined in IEEE802.11 Standard, authentication processing, registration of belonging relationship, and the like are performed between the wireless communication device 10 and the AP 20. When the belonging processing is completed, the wireless communication device 10 becomes communicable as the STA through the AP 20. As described above, detailed description of the operation conforming to the IEEE802.11 Standard is omitted.

There will be described a case where the STA 30 as a station attempts to establish connection with the wireless communication device 10 in this state. The STA 30 transmits Probe Request to search the AP.

Probe Request transmitted from the STA 30 is received by both the wireless communication device 10 and AP 20 (Step A6). As the normal AP operation, the AP 20 sends Probe Response in response to this Probe Request (Step A7′). The wireless communication device 10 also sends Probe Response in response to this Probe Request (Step A7). Since Probe Response is normally returned from only the AP, this operation is not the normal operation of the station, but a characteristic operation in this exemplary embodiment.

When receiving Probe Response from both the AP 20 and wireless communication device 10, the STA 30 recognizes that two APs exist. The STA 30 decides the AP to which the STA 30 belongs. A criterion for selection of the belonged AP is not specifically limited in this exemplary embodiment. In this exemplary embodiment, it is assumed that the STA 30 selects the wireless communication device 10 as the belonged AP.

When the STA 30 selects the AP 20 as the belonged AP, the AP 20 and the STA 30 perform the normal operation of the IEEE802.11 wireless LAN. Similarly, the wireless communication device 10 waits a response from the STA 30 for a certain time without performing any characteristic operation and then, performs the normal operation of the IEEE802.11 wireless LAN.

When the STA 30 selects the wireless communication device 10 as the belonged AP, the STA 30 transmits Authentication to the wireless communication device 10 and the belonging processing is started (Step A8).

When receiving Authentication, the wireless communication unit 11 recognizes that the STA 30 requests belonging to the AP. Then, before the wireless communication unit 11 changes the operating mode to the AP mode, in order to cancel belonging to the AP 20, the wireless communication unit 11 transmits Disassociation to the AP 20 (Step A9). Next, the wireless communication unit 11 instructs the state managing unit 12 to change the operating mode to the AP mode (Step A10). The processing for switching the operating mode (Step A9) may be started upon reception of Probe Request or Association Request rather than starting upon reception of Authentication. The wireless communication device 10 may perform processing in the AP mode while keeping the belonging state to the AP 20, without performing the processing in Step A9. In this case, the wireless communication device 10 performs processing as the STA belonging to the AP 20 and processing as the AP managing the STA 30 at the same time.

When the operating mode is changed to the AP mode, the wireless communication unit 11 starts the belonging processing. In the belonging processing, the wireless communication unit 11 transmits Authentication to the STA 30 and performs the authentication processing and the like. A specific procedure conforms to the IEEE802.11 Standard and thus, detailed description thereof is omitted. When the belonging processing by the wireless communication unit 11 is completed, the STA managing part 13 registers information on the STA 30 therein and thereafter, manages the STA 30 (Step A11).

In the AP mode, the wireless communication unit 11 periodically transmits Beacon and informs the surroundings of the existence of the AP as well as supports the power-saving function of the STA (Step A12). The wireless communication device 10 as the STA may continue communication under management of the AP 20 or may cancel belonging. In the latter case, the wireless communication unit 11 transmits Disassociation to the AP 20 and cancel belonging to the AP 20.

Next, operation in the case where the STA 30 cancels belonging will be described. Normally, in order to cancel belonging, the STA 30 transmits Disassociation (Step A13). When receiving Disassociation, the wireless communication unit 11 performs belonging cancellation processing and instructs the STA managing part 13 to record that belonging of the STA is canceled (Step A14).

When the number of belonging STAs becomes 0, the state managing unit 12 shifts the operating mode to “Assoc” (Step A15), transmits Authentication to the AP 20 and then, starts the belonging processing again (Step A16). Thereafter, the wireless communication device 10 operates as the STA. When the wireless communication device 10 as the STA continues communication under management of the AP20 (Step A9 is not performed), processing in Step A16 is unnecessary.

There may be a case where the STA 30 shuts off the power or the STA 30 is located outside of a region where a signal from the API can be received (out of range) and thus, becomes uncommunicable. In this case, the wireless communication device 10 returns to the Assoc mode at the timing when the wireless communication device 10 stops communication with the STA 30 for a certain time or more and starts the belonging processing to the AP 20.

In the above-mentioned operation, it is assumed that the STA 30 belongs to the wireless communication device 10 in the Assoc mode. However, the STA 30 may belong to the wireless communication device 10 in the Scanning mode. In this case, at the timing when Probe Request is received from the STA 30, the state managing unit 12 shifts the operating mode to the AP mode, and the wireless communication device 10 starts the belonging processing and transmission of Beacon. When the wireless communication device 10 cancels belonging or communication is interrupted for a certain time, the AP mode returns to the Scanning mode.

When the wireless communication device 10 operates in the STA mode, specifically, the Scanning mode or the Assoc mode, the state managing unit 12 instructs the power source control part 14 and the timer managing part 15 to periodically turn the power source for the wireless communication unit 11 OFF to reduce power consumption. This operation for reducing power consumption is defined as a power management feature in the IEEE802.11 Standard.

Next, effects of this exemplary embodiment will be described. In the communication system in this exemplary embodiment, upon request of other communication device, the wireless communication device can automatically change its operating mode to the AP mode or the STA mode. In other words, in the communication system in this exemplary embodiment, the wireless communication device can respond to Probe Request even during the operation in the STA mode and automatically change its operating mode to the AP mode upon reception of Authentication from the STA. Further, during the operation in the AP mode, at cancellation of belonging of the managed STA, the operating mode is automatically changed to the STA mode.

The communication system in this exemplary embodiment has an effect of reducing power consumption. In other words, even when the wireless communication terminal generally operates as the STA, the wireless communication terminal can also operate as the AP to which other STA belongs as needed to support the communication operation. By automatically changing the operating mode to the STA mode when the operation of the AP becomes unnecessary, the power-saving function of the STA, which is defined in the wireless LAN standard, can be utilized to the maximum extent.

### Fifth Exemplary Embodiment

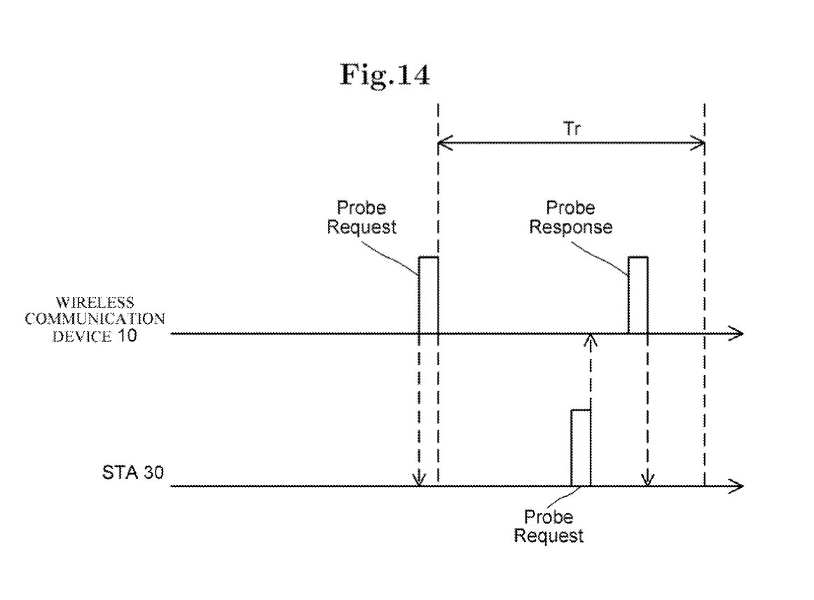

Next, Fifth exemplary embodiment of the present invention will be described with reference to FIG. 14. FIG. 14 is a timing chart showing operation of a wireless communication system in accordance with Fifth exemplary embodiment of the present invention. In Fourth exemplary embodiment, when the wireless communication device 10 operates in the STA mode, that is, in the Scanning mode or the Assoc mode, the wireless communication device 10 utilizes the power-saving function of the STA to reduce power consumption. In the power saving mode, the wireless communication device 10 uses the timer managing part 15 to turn the power source for the wireless transmitter-receiver OFF at regular intervals. For this reason, it is disadvantageously impossible to respond to Probe Request transmitted from the STA 30 during the power is turned OFF.

Thus, Fifth exemplary embodiment ensures that Probe Request transmitted from the STA 30 is received by the wireless communication device 10. This exemplary embodiment covers only the case where the wireless communication device 10 is in the Scanning mode.

In the Scanning mode, the wireless communication unit 11 transmits Probe Request at regular intervals. When transmitting Probe Request, the wireless communication unit 11 instructs the timer managing part 15 and the power source control part 14 to keep the power source for the wireless communication unit 11 ON for a certain time Tr. Tr is an arbitrary value.

When receiving Probe Request from the wireless communication device 10, the STA 30 transmits Probe Request within the time Tr from the reception. At this time, since the power source for the wireless communication unit 11 is kept ON, the wireless communication device 10 can reliably receive Probe Request. Operation after the wireless communication device 10 receives Probe Request from the STA 30 is the same as that in Fourth exemplary embodiment.

As described above, in the communication system in Fifth exemplary embodiment, the STA transmits Probe Request within a predetermined time when the power source for the wireless communication device is kept ON after the wireless communication device transmits Probe Request. For this reason, when the wireless communication device as the STA is in the power-saving state, even in the state where the wireless communication device probes without belonging to the AP, the operating mode can be advantageously switched to the AP mode for certain.

### Sixth Exemplary Embodiment

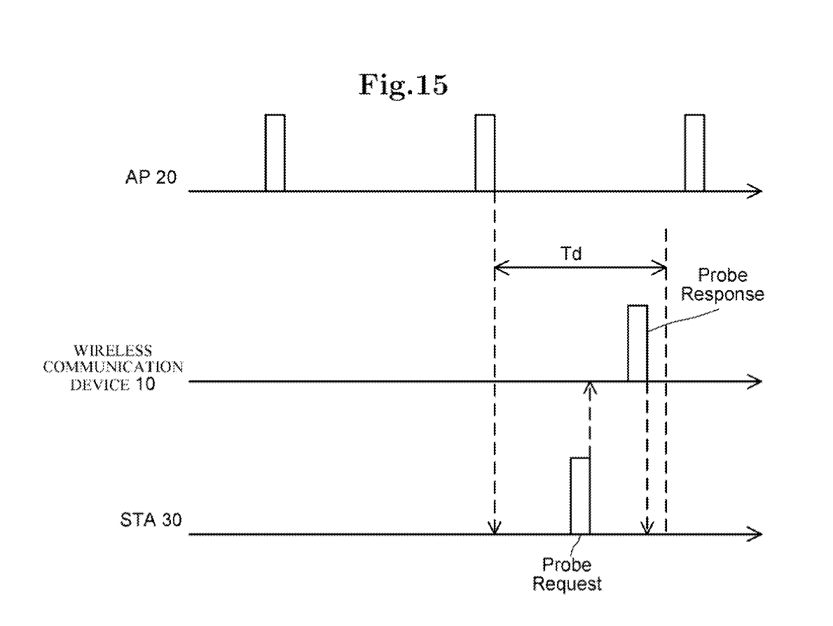

Next, an embodiment for carrying out a sixth aspect of the present invention will be described with reference to FIG. 15. FIG. 15 is a timing chart showing operation of a wireless communication system in accordance with Sixth exemplary embodiment of the present invention. In this exemplary embodiment, when the wireless communication device 10 is in the Assoc mode, Probe Request transmitted from the STA 30 can be reliably received.

The AP 20 periodically transmits Beacon. Thus, in the Assoc mode, the wireless communication device 10 turns the power source for the wireless communication unit 11 ON in sync with Beacon containing DTIM (Delivery Traffic Indication Message) having a value of 0. The DTIM refers to TIM (Traffic Indication Map) contained in Beacon transmitted at a timing when a value of a TSF (Time Synchronization Function) timer is 0, in the power saving mode of the IEEE802.11 wireless LAN. The DTIM contains various setting information necessary for power saving. The above-mentioned control method in the power-saving mode is a general method for the IEEE802.11 wireless LAN.

When receiving Beacon containing the DTIM having a value of 0, the wireless communication unit 11 instructs the timer managing part 15 and the power source control part 14 to keep the power source for the wireless communication unit 11 ON for a certain time Td. The Td is an arbitrary value.

The STA 30 observes Beacon issued from the surrounding AP before making the belonging request. When detecting Beacon containing the DTIM having a value of 0 among Beacon transmitted from the AP 20, the STA30 transmits Probe Request within the time Td. At this time, since the power source for the wireless communication unit 11 of the wireless communication device 10 is kept ON, Probe Request is reliably received by the wireless communication device 10. Operation after the wireless communication device 10 receives Probe Request from the STA 30 is the same as that in Fourth exemplary embodiment.

Next, effects of Sixth exemplary embodiment will be described. In the communication system in this exemplary embodiment, the STA transmits Probe Request within the time when the power source for the wireless communication device is kept ON immediately after transmission of Beacon. For this reason, in the state where the wireless communication device 10 is in the power-saving state, and in particular, belongs to the AP as the STA, the operation mode can be reliably switched to the AP mode.

By combining Sixth exemplary embodiment with Fifth exemplary embodiment, even if the wireless communication device 10 is in any state, the operation mode can be reliably switched to the AP mode.

The automatic switching method of the AP mode and the STA mode in Fourth to Sixth exemplary embodiments is effective for the communication device having the operating mode that manages other communication device and the operating mode that operates under management of other communication device, such as the wireless LAN.

### Seventh Exemplary Embodiment

Next, seventh exemplary embodiment of the present invention will be described. In this exemplary embodiment, configuration of the above-mentioned communication device and communication system will be briefly described.

A communication device in this exemplary embodiment is

a communication device that operates in a plurality of operating modes including:

a managing unit for controlling operation in a managing mode capable of managing a managed communication device, the managed communication device having a managed unit for controlling operation in a managed mode of performing communication under management of other communication device; and

an operating mode setting unit for changing the operating mode to the managing mode when the communication device receives a response request signal from the managed communication device during operation in another operating than the managing mode.

The communication device

includes the managed unit for controlling the operation in the managed mode of performing communication under management of a managing communication device that can manage the communication operation of the other communication device, and

the operating mode setting unit changes the operating mode to the managing mode when the communication device receives the response request signal during the operation in the managed mode.

In the communication device,

the operating mode setting unit changes the operating mode to another operating mode than the managing mode when the communication device receives a management cancellation request signal for requesting management from the managed communication device during the operation in the managing mode.

Further, in the communication device,

the operating mode setting unit changes the operating mode to another operating mode than the managing mode when the communication device satisfies a preset condition for the communication state with the managed communication device during the operation in the managing mode.

Further, in the communication device,

the operating mode setting unit changes the operating mode to another operating mode than the managing mode when management of the managed communication device is disabled during operation of the communication device in the managing mode.

Then, the operating mode setting unit changes the operating mode to another operating mode than the managing mode when the communication device does not receive a signal from the managed communication device for a predetermined time during operation in the managing mode.

Further, in the communication device,

the managing unit transmits a management signal for managing the managed communication device when the communication device operates in the managing mode. At this time, the managing unit stops transmission of the management signal when the operating mode is changed to another operating mode than the managing mode. Further, the managing unit stops transmission of the management signal when the communication device receives a management cancellation request signal for requesting cancellation of management from the managed communication device during operation of the communication device in the managing mode. Further, the managing unit stops transmission of the management signal when management of the managed communication device is disabled during operation of the communication device in the managing mode. Furthermore, the managing unit stops transmission of the management signal when the communication device receives a signal from the managed communication device for a predetermined time during operation of the communication device in the managing mode.

Further, in the communication device, for a predetermined time or more from transmission of a first signal to other communication device, a state where the response request signal transmitted from the managed communication device can be received is kept. Further, for a predetermined time or more from reception of a second signal from other communication device, a state where the response request signal transmitted from the managed communication device can be received is kept.

Further, in the communication device,

the managing unit controls operation in the managing mode so as to manage a mobile station via a wireless communication unit, and

the operating mode setting unit changes the operating mode to the managing mode when the communication device receives the response request signal from the mobile station.

When the number of the mobile stations managed by the managing unit becomes 0, the operating mode setting unit changes the operating mode to another operating mode than the managing mode. Further, the response request signal is included in a predetermined managing operation control frame transmitted from the mobile station.

Further, in the communication device, the wireless communication unit conforms to the IEEE802.11 wireless LAN (Local Area Network) standard standardized by the Institute of Electrical and Electronic Engineers (IEEE) 802 committee. The response request signal transmitted from the mobile station is included in any of Probe Request, Authentication and Association Request. Further, the managing unit transmits Beacon when the communication device operates in the managing mode. Further, the Beacon includes DTIM (Delivery Traffic Indication Message).

In the communication device, for a predetermined time or more from transmission of Probe Request to other communication device, a state where the response request signal transmitted from the mobile station can be received is kept. Further, in the communication device, for a predetermined time or more from reception of Beacon from other communication device, a state where the response request signal transmitted from the mobile station can be received is kept.

Further, in the communication device, the managed unit controls operation in the managed mode of operating as a mobile station under management of a base station. Then, the managed unit can perform operation in the managed mode even when the communication device operates in the managing mode.

Further, within a predetermined time from reception of the first signal, the communication device transmits the response request signal to the other communication device that transmits the first signal and is kept so as to be able to receive the response request signal.

Further, within a predetermined time from reception of the second signal, the communication device transmits the response request signal to the other communication device that receives the second signal and is kept so as to be able to receive the response request signal.

Further, a communication system as another aspect of the present invention includes a communication device that operates in a plurality of operating modes, and a managed communication device having a managed unit for controlling operation in a managed mode of performing communication under management of other communication device.

The communication device includes a managing unit for controlling operation in a managing mode capable of managing the managed communication device, and an operating mode setting unit for changing the operating mode to the managing mode when the communication device receives a response request signal from the managed communication device during operation in another operating mode than the managing mode.

The communication system includes a managing communication device capable of managing a communication operation of other communication device,

the communication device includes the managed unit for controlling operation in the managed mode of performing communication under management of the managing communication device, and

the operating mode setting unit changes the operating mode from the managed mode to the managing mode when the communication device receives the response request signal during operation in the managed mode.

Furthermore, in the communication system, the managed unit can control operation in the managed mode even when the communication device operates in the managing mode.

Further, in a communication control method as another aspect of the present invention, during operation in another operating mode than a managing mode capable of managing other communication device, when a response request signal is received the other communication device, the operating mode is changed to the managing mode.

Furthermore, a program as another aspect of the present invention is a communication control program by which a computer for controlling a communication device implements, during operation in another operating mode than a managing mode capable of managing other communication device, when the communication device receives a response request signal from the other communication device, a unit for changing the operating mode to the managing mode. This communication control program is stored in a computer-readable recording medium and becomes available by being read by the computer.

Although the present invention has been described with reference to each of the above-mentioned embodiments, the present invention is not limited to the above-mentioned embodiments. The configuration and details of the present invention can be variously modified within the scope of the present invention so that those skilled in the art can understand.

This application is based upon and claims the benefit of priority from Japanese patent application No. 2008-322093, filed on Dec. 18, 2008, the disclosure of which is incorporated herein in its entirety by reference.

### DESCRIPTION OF REFERENCE NUMERALS

1 communication device
2 operating mode setting unit
3 managing unit
5 managed communication device
6 managed unit
7 managing communication device
10 wireless communication device
11 wireless communication unit
12 state managing unit
13 STA managing part
14 power source control part
15 timer managing part
20 AP
30 STA
40 wireless LAN

1. A communication device that operates in a plurality of operating modes comprising:
a managing unit for controlling operation in a managing mode capable of managing a managed communication device, the managed communication device having a managed unit for controlling operation in a managed mode of performing communication under management of the other communication device; and
an operating mode setting unit for changing the operating mode to the managing mode when the communication device receives a response request signal from the managed communication device during operation in another operating mode than the managing mode.

2. The communication device as stated in claim 1, including the managed unit for controlling the operation in the managed mode of performing communication under management of a managing communication device that can manage the communication operation of the other communication device, wherein
the operating mode setting unit changes the operating mode to the managing mode when the communication device receives the response request signal during the operation in the managed mode.

3. The communication system as stated in claim 1, wherein
the operating mode setting unit changes the operating mode to another operating mode than the managing mode when the communication device receives a management cancellation request signal for requesting cancellation of management from the managed communication device during the operation in the managing mode.

4. The communication system as stated in claim 1, wherein
the operating mode setting unit changes the operating mode to another operating mode than the managing mode when the communication device satisfies a preset condition for the communication state with the managed communication device during the operation in the managing mode.

5. The communication system as stated in claim 1, wherein
the operating mode setting unit changes the operating mode to another operating mode than the managing mode when management of the managed communication device is disabled during operation of the communication device in the managing mode.

6. The communication system as stated in claim 4, wherein
the operating mode setting unit changes the operating mode to another operating mode than the managing mode when the communication device does not receive a signal from the managed communication device for a predetermined time during operation in the managing mode.

7. The communication system as stated in claim 1, wherein
the managing unit transmits a management signal for managing the managed communication device when the communication device operates in the managing mode.

8. The communication system as stated in claim 7, wherein
the managing unit stops transmission of the management signal when the operating mode is changed to another operating mode than the managing mode.

9. The communication system as stated in claim 7, wherein
the managing unit stops transmission of the management signal when the communication device receives a management cancellation request signal for requesting cancellation of management from the managed communication device during operation of the communication device in the managing mode.

10. The communication system as stated in claim 7, wherein
the managing unit stops transmission of the management signal when management of the managed communication device is disabled during operation of the communication device in the managing mode.

11. The communication system as stated in claim 10, wherein
the managing unit stops transmission of the management signal when the communication device does not receive a signal from the managed communication device for a predetermined time during operation of the communication device in the managing mode.

12. The communication system as stated in claim 1, wherein
for a predetermined time or more from transmission of a first signal to other communication device, a state where the response request signal transmitted from the managed communication device can be received is kept.

13. The communication system as stated in claim 1, wherein
for a predetermined time or more from reception of a second signal from other communication device, a state where the response request signal transmitted from the managed communication device can be received is kept.

14. The communication system as stated in claim 1, wherein
the managing unit controls operation in the managing mode so as to manage a mobile station via a wireless communication unit, and
the operating mode setting unit changes the operating mode to the managing mode when the communication device receives the response request signal from the mobile station.

15. The communication system as stated in claim 14, wherein
the operating mode setting unit changes the operating mode to another operating mode than the managing mode when the number of the mobile stations managed by the managing means unit becomes 0.

16. The wireless communication system as stated in claim 14, wherein
the response request signal is included in a predetermined managing operation control frame transmitted from the mobile station.

17. The communication system as stated in claim 14, wherein
the wireless communication unit conforms to the IEEE802.11 wireless LAN (Local Area Network) standard standardized by the Institute of Electrical and Electronic Engineers (IEEE) 802 committee.

18. The communication system as stated in claim 17, wherein
the response request signal transmitted from the mobile station is included in any of Probe Request, Authentication and Association Request.

19. The wireless communication system as stated in claim 17, wherein
the managing unit transmits Beacon when the communication device operates in the managing mode.

20. The communication system as stated in claim 19, wherein
the Beacon includes DTIM (Delivery Traffic Indication Message).

21. The communication system as stated in claim 17, wherein
for a predetermined time or more from transmission of Probe Request to other communication device, a state where the response request signal transmitted from the mobile station can be received is kept.

22. The communication system as stated in claim 17, wherein
for a predetermined time or more from reception of Beacon from other communication device, a state where the response request signal transmitted from the mobile station can be received is kept.

23. The communication system as stated in claim 2, wherein
the managed unit controls operation in the managed mode of operating as a mobile station under management of a base station.

24. The communication system as stated in claim 2, wherein
the managed unit can process operation in the managed mode even when the communication device operates in the managing mode.

25. A communication device that transmits the response request signal to the communication device as stated in claim 12 within a predetermined time from reception of the first signal.

26. A communication device that transmits the response request signal to the communication device as stated in claim 13 within a predetermined time from reception of the second signal.

27. A communication system comprising: a communication device that operates in a plurality of operating modes; and a managed communication device having a managed unit for controlling operation in a managed mode of performing communication under management of the other communication device, wherein
the communication device includes a managing unit for controlling operation in a managing mode capable of managing the managed communication device, and an operating mode setting unit for changing the operating mode to the managing mode when the communication device receives a response request signal from the managed communication device during operation in another operating mode than the managing mode.

28. The communication system as stated in claim 27, including a managing communication device capable of managing a communication operation of other communication device, wherein
the communication device includes the managed unit for controlling operation in the managed mode of performing communication under management of the managing communication device, and
the operating mode setting unit changes the operating mode from the managed mode to the managing mode when the communication device receives the response request signal during operation in the managed mode.

29. The communication system as stated in claim 28, wherein
the managed unit can control operation in the managed mode even when the communication device operates in the managing mode.

30. A communication control method, wherein
during operation in another operating mode than a managing mode capable of managing other communication device, when a response request signal is received the other communication device, the operating mode is changed to the managing mode.

31. A computer-readable recording medium for recording a communication control program by which a computer for controlling a communication device implements
during operation in another operating mode than a managing mode capable of managing other communication device, when the communication device receives a response request signal from the other communication device, a unit for changing the operating mode to the managing mode.

32. (canceled)

33. A communication device that operates in a plurality of operating modes comprising:
a managing means for controlling operation in a managing mode capable of managing a managed communication device, the managed communication device having a managed means for controlling operation in a managed mode of performing communication under management of the other communication device; and
an operating mode setting means for changing the operating mode to the managing mode when the communication device receives a response request signal from the managed communication device during operation in another operating mode than the managing mode.
